(19) United States
(12) Patent Application Publication
(10) Pub. No.: US 2019/0019481 A1
(43) Pub. Date: Jan. 17, 2019

(54) MUTE RACK WITH PALETTE SHAPE AND MULTIPLE RETENTION HOLES

(71) Applicant: Steven D. Klein, Monterey Park, CA (US)

(72) Inventor: Steven D. Klein, Monterey Park, CA (US)

(21) Appl. No.: 16/015,646

(22) Filed: Jun. 22, 2018

Related U.S. Application Data
(60) Provisional application No. 62/532,056, filed on Jul. 13, 2017.

(51) Int. Cl. G10G 5/00; G10D 9/06

(52) U.S. Cl. CPC G10G 5/00; G10D 9/06

(57) ABSTRACT

A mute rack with palette shape and multiple retention apertures for retaining wind instrument mutes and music related items in upright position. The mute rack provides a palette-shaped panel defined by an edge, a left region, and a right region. The left and right regions join together at a junction region. The left region forms multiple left apertures, the right region forms multiple right apertures, and the junction region forms a junction aperture, with at least one of the apertures having a different dimension. A clamp bar detachably attaches the panel to a rod, like a music stand. The clamp bar comprises a torque mechanism that is rotatably manipulated to detachably attach to the rod. The clamp bar also comprises a bracket fixedly mated with the edge of the panel. The bracket forms a hole that enables passage of a screw of the torque mechanism for tightening against the rod.

### CROSS REFERENCE OF RELATED APPLICATIONS

This application claims the benefits of U.S. provisional application No. 62/532,056, filed Jul. 13, 2017 and entitled PALETTE-SHAPED WIND INSTRUMENT MUTE RETENTION DEVICE, which provisional application is incorporated by reference herein in its entirety.

### FIELD OF THE INVENTION

The present invention relates generally to a mute rack with palette shape and multiple retention apertures for receiving and retaining wind instrument mutes, and other music related items. More so, a mute rack is defined by a generally palette shaped panel that forms variously sized and dimensioned apertures for the simultaneous retention and selective positioning of correspondingly sized and dimensioned wind instrument mutes, writing instruments, tuning forks, sticks, reeds, and instrument containers in an upright position within correspondingly shaped and sized apertures, so that the mutes and other items may be easily accessible by a musician who is playing a musical instrument.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, an instrument mute is a cone shaped device used by musicians to mute the sound from a wind instrument. The mute is often attached to or inserted into a musical instrument to soften or alter its tone The mute may include corks at or near its narrow end to hold the mute in the bell of the cornet, trombone, or other instrument. In many instances, the mute is inserted into the ring portion of conventional mute holders by its narrow end. The wide end of the conic mute rests against the ring, which encircles it. Then when the mute is needed, the mute is lifted entirely out through the ring.

The tone of certain musical instruments, such as the trumpet, trombone and other wind instruments can be modified by the use of a number of differently sized and dimensioned mutes. Thus, it is known in the art to use several mutes during the course of a single session of play, or even a single musical piece. It is frequently the case that a first mute, currently being used, must be rapidly swapped during the course of play for a second mute, which is needed to continue play. In many cases, this swap results in some rapid fumbling around as the player attempts to remove the first mute and replace the second mute. Where the player is overly hurried, the first mute may not be put into a location where it may be easily reached later. This disorganized assembly of mutes can adversely affect the performance of the musician.

Other proposals have involved devices to retain instrument mutes while the musician is playing the instrument. The problem with these mute retention devices is that they do not hold variously sized and dimensioned mutes. Also, they can tip over by not being balanced. Even though the above cited devices to retain instrument mutes meet some of the needs of the market, a mute rack having a palette shape and multiple retention holes for the simultaneous retention and selective positioning of correspondingly sized and dimensioned wind instrument mutes, writing instruments, tuning forks, sticks, reeds, and instrument containers in an upright position, so that the mutes and other items may be easily accessible by a musician who is playing a musical instrument is still desired.

### SUMMARY

Illustrative embodiments of the disclosure are generally directed to a mute rack with palette shape and multiple retention holes for retaining wind instrument mutes and music related items in an upright and convenient manner.

In some embodiments, the mute rack may include a generally palette-shaped panel that forms variously sized and dimensioned apertures for the simultaneous retention and selective positioning of correspondingly sized and dimensioned wind instrument mutes, writing instruments, tuning forks, sticks, reeds, and instrument containers. The mute rack holds the mutes in an upright position within their respective apertures to enhance drainage and drying of moisture on the mute. Further, the mute rack securely attaches to a music stand directly in front of the musician. In this manner, the mutes and music related items are easily accessible by a musician during a musical performance.

In one non-limiting embodiment, the mute rack provides a palette-shaped panel that is defined by an edge, a left region, and a right region. The left and right regions join together at a junction region. The junction region forms a gap for the wind instrument and the musician to operate and also creates a balance mute rack. The left region forms multiple left apertures, the right region forms multiple right apertures, and the junction region forms at least one junction aperture. The left, right, and junction apertures have different shapes or, dimensions, or both.

The palette shape of the panel is what provides an enhanced musical instrument playing experience by allowing the musician quick, efficient access to different mutes from either a left region or a right region of the panel during a musical performance. The palette-shaped panel also has a junction region that forms a gap directly in front of the musician, so as to provide additional space for the musician to move around, access mutes, and manipulate the musical instrument.

Further, the mute rack provides a clamp bar for supporting the palette-shaped panel to a rod, such as that from a music stand or other supporting structure proximal to the musician. The clamp bar comprises a torque mechanism that is rotatably manipulated in a screwing motion to enable detachable attachment to the rod. The clamp bar further comprises a bracket that fixedly mates with the edge of the junction region of the panel. The bracket forms a hole that enables passage of the screw of the torque mechanism for tightening against the rod.

In another aspect, the left and right regions of the palette-shaped panel are symmetrically the same.

In another aspect, the multiple left apertures are circular.

In another aspect, the multiple left apertures comprises two circles.

In another aspect, the multiple right apertures are circular.

In another aspect, the multiple right apertures comprises two circles.

In another aspect, the at least one junction aperture is one circle.

In another aspect, the torque mechanism comprises a handle, a screw, and a nut.

In another aspect, the bracket has a V-shape that mates with the gap in the junction region.

In another aspect, the panel is fabricated from at least one of the following: metal, wood, a rigid polymer, a silicone, and rubber.

One objective of the present invention is to provide a mute rack that can retain multiple wind instrument mutes in an upright position and provide variously sized and shaped apertures for the positioning of the mutes and efficient access while playing a wind instrument.

Another objective is to hold the mutes in an upright position within their respective apertures to enhance drainage and drying of moisture on the mute.

Another objective is to provide a mute rack that is easily coupled to various sizes and shapes of music stands.

Another objective is to provide adjustment means to align the bracket and clamp bar along the rod in a desired position.

Another objective is to provide apertures on the palette-shaped panel for containing instrument mutes, writing instruments, instrument oil containers, and mouthpieces.

Another objective is to provide a balanced mute rack.

Another objective is to provide an inexpensive to manufacture palette-shaped mute rack.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary mute rack with palette shape and multiple retention holes for retaining variously sized wind instrument mutes and a music related item, in accordance with an embodiment of the present invention;

FIG. 2 illustrates a top view of a mute rack, in accordance with an embodiment of the present invention;

FIG. 3 illustrates a perspective view of the mute rack shown in FIG. 2, in accordance with an embodiment of the present invention; and

FIG. 4 illustrates a perspective view of a mute rack attached to a music stand through use of a clamp bar, in accordance with an embodiment of the present invention.

Like reference numerals refer to like parts throughout the various views of the drawings.

### DETAILED DESCRIPTION OF THE INVENTION

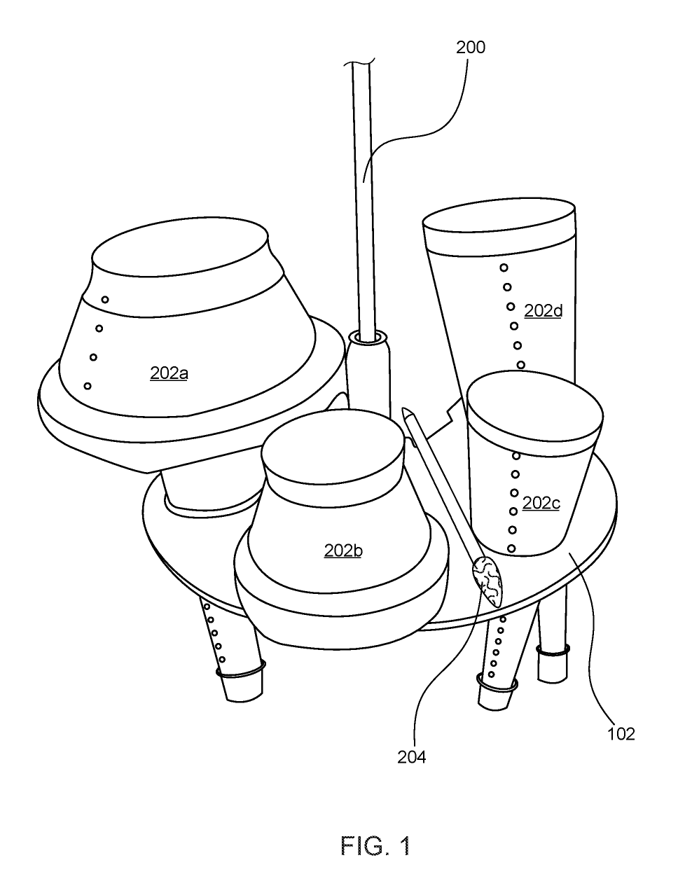

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

FIGS. 1-4 reference a mute rack 100 with palette shape and multiple retention apertures for receiving and retaining multiple, variously sized wind instrument mutes 202a, 202b, 202c, 202d, and other music related items 204. As illustrated in FIG. 1, the mute rack 100 is configured to conveniently hold variously sized and dimensioned wind instrument mutes 202a-d, writing instruments 204, tuning forks, sticks, reeds, and instrument containers in an upright and easy to access position directly in front of the musician. In this manner, the mutes and other items may be easily accessible by a musician who is playing a musical instrument is still desired. Further, the wind instrument mutes 202a-d and music related item 204 may be easily accessible by a musician who is playing a musical instrument.

The palette shape of the panel 102 is what provides the enhanced musical instrument playing experience by allowing the musician quick, efficient access to different mutes 202a-d from either a left region 106 or a right region 110 of the panel 102 during a musical performance. The palette-shaped panel 102 also has a junction region 114 that forms a gap 124 directly in front of the musician, so as to provide additional space for the musician to move around, access mutes, and manipulate the musical instrument.

In one non-limiting embodiment, the mute rack 100 includes a generally palette-shaped panel 102 having a generally flat surface and an edge 104. The unique palette shape of the panel 102 resembles a heart shape, or a somewhat flattish slate object having various shapes, and containing a recessed area. The panel 102 is generally rigid, and chiefly unique in its palette shape that divides it into a left region 106 and a right region 110. By dividing the panel 102 in such a manner, the musician has a more organized retention of the mutes, and access thereto.

In one possible embodiment, the panel 102 is defined by a left region 106 and a symmetrically similar right region 110 that join together at a junction region 114. The junction region 114 forms a gap 124 to provide the musician, or the musician's knee, with greater space to operate the wind instrument and move around comfortably. In this manner, either the left region 106 or right region 110 can be closer to the musician, while the junction region 114 forms a gap 124 for the wind instrument while the musician is playing and manipulating the wind instrument.

In some embodiments, the left region 106 of the panel 102 forms multiple left apertures 108a, 108b. The right region 110 of the panel 102 forms multiple right apertures 112a, 112b. The junction region 114 forms at least one junction aperture 116. The left and right apertures 108a-b, 112a-b have different shapes and dimensions corresponding to variously sized and dimensioned wind instrument mutes 202a-d. The junction aperture 116 is generally smaller than the left and right apertures 108a-b, 112a-b, and is configured to receive the writing instruments, tuning forks, sticks, reeds, and containers. In this manner, variously sized and styles wind instrument mutes, writing instruments, tuning forks, sticks, reeds, and containers can be selectively placed in the appropriate apertures 108a-b, 112a-b, 116 that form in the panel 102.

In some embodiments, the mute rack 100 provides a clamp bar 118 that joins with the panel 102 and allows for detachable attachment to a rod 200, such as a music stand or other supportive mounting structure proximal to the musician. The clamp bar 118 comprises a torque mechanism 120 that may be rotatably manipulated to enable detachable attachment to the rod 200. The clamp bar 118 further comprises a bracket 122 having a V-shape to fixedly mate with the edge 104 of the junction region 114, between the left and right regions 106, 110. Further, the bracket 122 comprises a hole that allows the torque mechanism 120 to pass through for tightening and loosening the clamp bar 118 to the rod.

Those skilled in the art will recognize that a conventional instrument can include a ring and a clamp member for clamping to a music stand or the like. An instrument mute is typically cone shaped, with a number of corks at or near its narrow end to hold the mute in the bell of the cornet, trombone, or other instrument. In many instances, the mute is inserted into the ring portion of conventional mute holders by its narrow end. The wide end of the conic mute rests against the ring, which encircles it. Then when the mute is needed, the mute is lifted entirely out through the ring.

In some embodiments, the instrument may include, without limitation, a trumpet, cornet, a trombone, a woodwind, and a brass instrument. The mute 202a-d that is operational with the instrument may include a generally conical-shaped or cone-shaped mute shaped for operation with the trumpet, the cornet, and the trombone. Often, the mute has a generally, cone shape with a number of corks at or near its narrow end to hold the mute in the bell of the cornet, trombone, or other instrument.

Furthermore, the mute is known in the art to attach to a music stand, near the musician to enable easy access while the musician plays the instrument. The left, right, and junction regions of the panel 102 may also provide apertures 108a-b, 112a-b, 116 that enable stowage and easy accessibility of instrument related items, such as writing instruments, oil containers, mouthpieces, and the like.

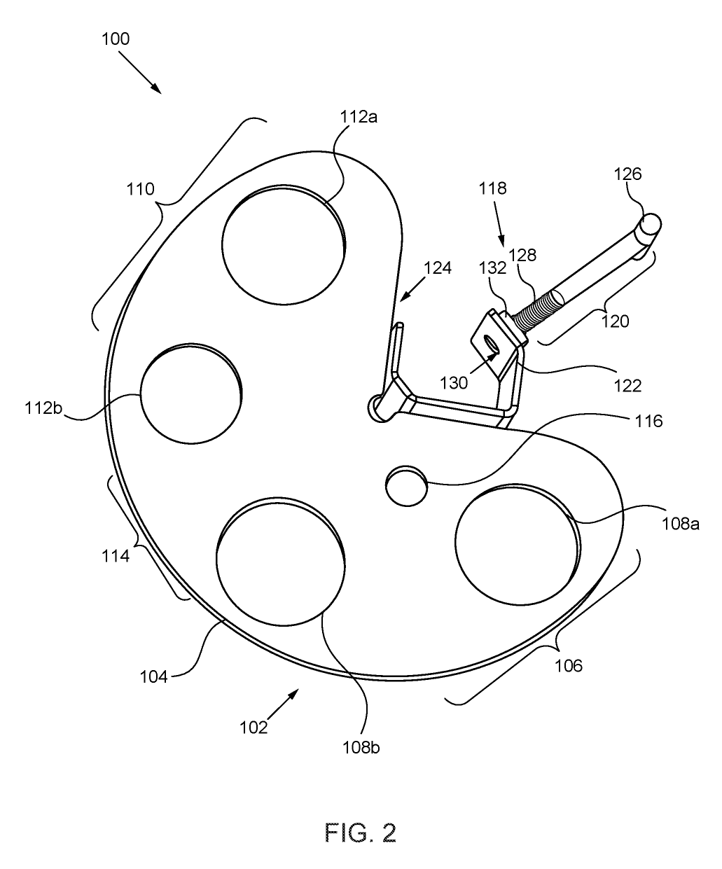

As referenced in FIG. 2, the mute rack 100 comprises a palette-shaped panel 102 that is defined by an edge 104, a left region 106, and a right region 110. The left and right regions 106, 110 join together at a junction region 114 in a unique disposition that forms a gap 124 about at the junction region 114. By providing a palette shape for the panel 102, either the left or right region 106, 110 can be closer to the musician, while the more distal region is further away, enabling extra gap for the instrument or the musician's knee. In one embodiment, the left and right regions 106, 110 are configured to have symmetrical dimensions. In another embodiment, the panel 102 and both regions 106, 110 thereof are fabricated from metal, wood, a rigid polymer, a silicone, and rubber.

In some embodiments, the left region 106 of the panel 102 forms multiple left apertures 108a, 108b. The left apertures 108a-b are generally circular, so as to receive a wind instrument mute. In other embodiments, two left apertures 108a-b may form in the left region 106. In one embodiment, the left apertures 108a, 108b are circular, including two large openings in the panel 102. Though in other embodiments, the apertures 108a-b can follow other shapes corresponding to mutes being retained. For example, FIG. 1 shows a wide mute being retained in a left aperture 108a.

Similarly, the right region 110 of the panel 102 forms multiple right apertures 112a, 112b. In one embodiment, two right apertures 112a-b forms. In some embodiments, the right apertures 112a-b are circular, including two large openings in the panel 102. Though in other embodiments, the right apertures 112a-b may follow other shapes corresponding to mutes being retained. For example, FIG. 1 shows a narrow mute being retained in a right aperture 112b.

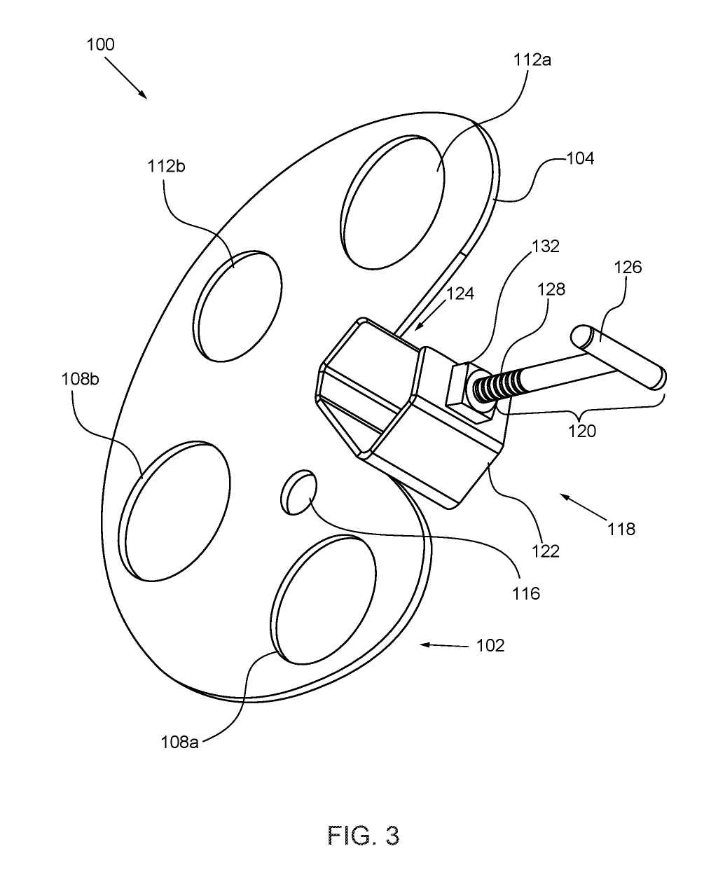

FIG. 3 shows the junction region 114 of the panel 102 forming at least one junction aperture 116, which can also be used to retain mutes 202a-d. In one embodiment, the junction aperture 116 is a singular circular opening through the panel 102. Though in other embodiments, the junction aperture 116 may follow other shapes corresponding to mute that is retained therein. In some embodiments, the left, right, and junction aperture 108a-b, 112a-b, 116 are configured with different shapes or, dimensions, or both. In this manner, variously sized and styles writing instruments, tuning forks, sticks, reeds, and containers selectively position in the junction aperture 116.

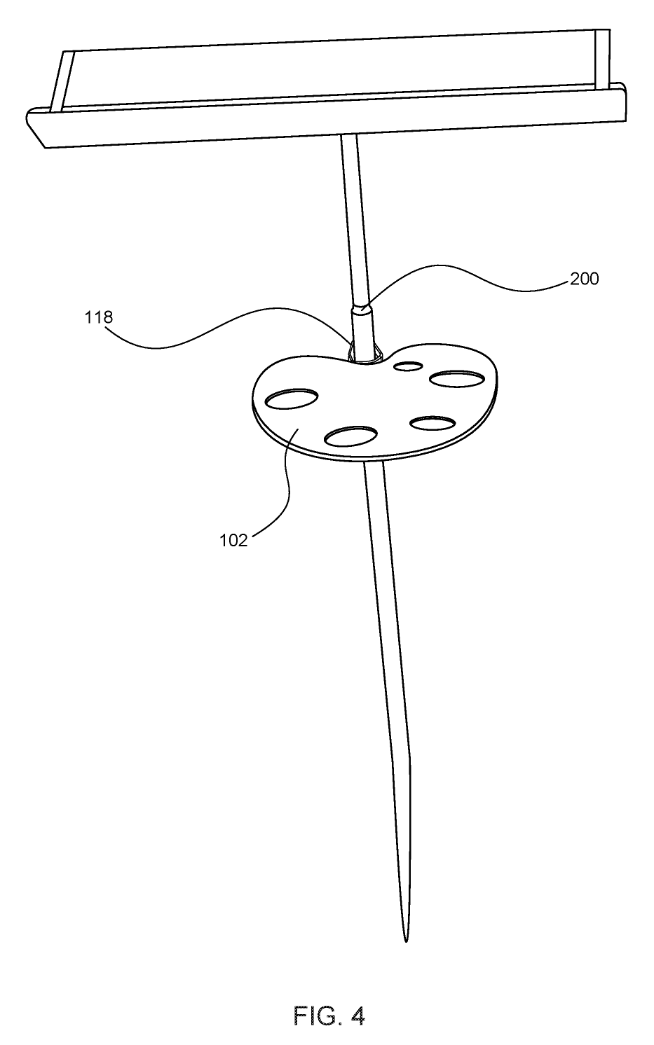

Looking now at FIG. 4, the mute rack 100 detachably attaches to a rod 200 through use of a clamp bar 118 that also fixedly joins with the panel 102. In one embodiment, the rod 200 may include a music stand used to hold musical sheets and music related items 204. In this manner, the mute rack 100 may detachably couple to music stands having different sizes and shapes.

In some embodiments, the clamp bar 118 may include a torque mechanism 120 that is configured to be rotatably manipulated, so as to enable detachable attachment to the rod 200. The torque mechanism 120 may include a handle 126 and a screw 128. A nut 132 may be operational therebetween to provide spacing for the screw 128 and enhance the frictional relationships. The handle 126 rotatably manipulates the screw 128 to press against the rod 200, so as to create a frictional relationship that holds the panel 102 against the rod 200.

In some embodiments, the clamp bar 118 also comprises a bracket 122. The bracket 122 is the anchoring part that fixedly mates with the edge 104 of the junction region 114 of the panel 102. In one embodiment, the bracket 122 has a V-shape that corresponds with the gap 124 that forms in the junction region of the panel 102. The gap 124 is a result of the left and right regions 106, 110 of the panel forming a heart shape.

In one embodiment, the bracket 122 forms a hole 130 that allows the screw 128 of the torque mechanism 120 to pass through. In this manner, the screw 128 can be rotatably manipulated by the handle 126 to press directly against the rod 200; and thereby tighten and loosen the bracket 122 to the rod 200. Also, the terminus of the screw engages the rod 200 and also allows the torque mechanism 120 and panel 102 to rotate about the rod 200 for convenient access to the mutes by the musician. In one possible embodiment, the torque mechanism 120 may include a clamp thread that wraps around the rod. The threaded configuration enables adjustable manipulation of the freedom of rotation by the left and right regions 110, as described below.

In operation, a musician removes the musical instrument and the mute rack 100 from an instrument case. A music stand positions adjacently to the musician in preparation for playing the instrument. The clamp bar 118 on the mute rack 100 is loosened to enable coupling with the rod on the music stand. The torque mechanism 120, such as the screw, can be adjusted to accommodate ½″ or 1″ diameter rods. A handle 126 can be grasped to rotate the screw 128. A nut 132 may be used to provide spacing for the screw.

The mute can be placed into the apertures 108a-b, 112a-b, 116 that allows partial passage. However, if the user wishes to use multiple mutes, the panel 102 can be rotated horizontally to achieve a desired position for retaining the mutes. For example, a first mute retained in a left aperture is positioned directly in front of the musician, while a second mute retained in a right aperture is rotated to the left of the musician. The musician then has easy access to both mutes simultaneously. When the musician has completed playing the instrument, the torque mechanism 120 is loosened, and the mute rack 100 is detached from the music stand rod for stowage into the instrument case.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A mute rack, the mute rack comprising:
a generally palette-shaped panel defined by an edge, a left region, and a right region, the left and right regions joining at a junction region, the junction region forming a gap,
the left region of the panel defined by multiple left apertures,
the right region of the panel defined by multiple right apertures,
the junction region of the panel defined by at least one junction aperture,
the left apertures, right apertures, and junction aperture having at least one differently shaped aperture from the others; and
a clamp bar fixedly attached to the panel, the clamp bar comprising a torque mechanism, the clamp bar further comprising a bracket, the bracket being fixedly mated with the edge of the panel, the bracket being defined by a hole for enabling passage of the torque mechanism.

2. The mute rack of claim 1, wherein the left and right regions of the panel have substantially the same dimensions.

3. The mute rack of claim 1, wherein the multiple left apertures are circular.

4. The mute rack of claim 1, wherein the multiple left apertures comprises two circles.

5. The mute rack of claim 1, wherein the multiple right apertures are circular.

6. The mute rack of claim 1, wherein the multiple right apertures comprises two circles.

7. The mute rack of claim 1, wherein the at least one junction aperture is one circle.

8. The mute rack of claim 1, wherein the panel is fabricated from at least one of the following: metal, wood, a rigid polymer, a silicone, and rubber.

9. The mute rack of claim 1, wherein multiple wind instrument mutes selectively position in a correspondingly sized and dimensioned aperture in the panel.

10. The mute rack of claim 1, wherein the bracket is fixedly mated with the edge of the junction region of the panel.

11. The mute rack of claim 1, wherein the bracket is defined by a V-shape that fills the gap formed in the junction region.

12. The mute rack of claim 1, wherein the torque mechanism comprises a handle and a screw.

13. The mute rack of claim 12, wherein the clamp bar detachably attaches to a rod.

14. The mute rack of claim 13, wherein the rod is a music stand.

15. The mute rack of claim 14, wherein the screw of torque mechanism passes through the hole formed in the bracket for tightening and loosening the clamp bar to the rod

16. A mute rack, the mute rack comprising:
a generally palette-shaped panel defined by an edge, a left region, and a right region, the left and right regions joining at a junction region, the junction region forming a gap, the left and right regions of the panel having substantially the same dimensions,
the left region of the panel defined by multiple left apertures,
the right region of the panel defined by multiple right apertures,
the junction region of the panel defined by at least one junction aperture,
the left apertures, right apertures, and junction aperture having at least one differently shaped aperture from the others; and
a clamp bar fixedly attached to the panel, the clamp bar comprising a torque mechanism, the torque mechanism rotatably manipulated to enable detachable attachment to a rod, the clamp bar further comprising a bracket, the bracket being fixedly mated with the edge of the junction region of the panel, the bracket being defined by a hole for enabling passage of the torque mechanism,
whereby the torque mechanism passes through the hole for tightening and loosening the clamp bar to the rod.

17. The mute rack of claim 16, wherein the left apertures, right apertures, and junction aperture have a generally circular shape.

18. The mute rack of claim 16, wherein the bracket is defined by a V-shape that fills the gap formed in the junction region.

19. The mute rack of claim 16, wherein the torque mechanism comprises a handle, a screw, and a nut.

20. A mute rack, the mute rack consisting of:
a generally palette-shaped panel defined by an edge, a left region, and a right region, the left and right regions joining at a junction region, the junction region forming a gap, the left and right regions of the panel having substantially the same dimensions,
the left region of the panel defined by multiple left apertures,
the right region of the panel defined by multiple right apertures,
the junction region of the panel defined by at least one junction aperture,
the left apertures, right apertures, and junction aperture having at least one differently shaped aperture from the others; and
a clamp bar fixedly attached to the panel, the clamp bar comprising a torque mechanism, the torque mechanism comprising a handle, a screw, and a nut, the handle of the torque mechanism rotatably manipulating the screw to enable detachable attachment to a rod, the clamp bar further comprising a bracket fixedly mated with the edge of the panel, the bracket being defined by a hole for enabling passage of the screw of the torque mechanism,
whereby the screw of the torque mechanism passes through the hole forming in the bracket for tightening and loosening the clamp bar to the rod.
